(19) United States
(12) Patent Application Publication
(10) Pub. No.: US 2023/0107213 A1
(43) Pub. Date: Apr. 6, 2023

(54) METHOD OF GENERATING VIRTUAL CHARACTER, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Jiaying LIU, Beijing (CN); Haotian PENG, Beijing (CN); Shihui XU, Beijing (CN)

(73) Assignee: BEIJING BAIDU NETCOM SCIENCE TECHNOLOGY CO., LTD., Beijing (CN)

(21) Appl. No.: 18/080,145

(22) Filed: Dec. 13, 2022

(30) Foreign Application Priority Data
Dec. 13, 2021 (CN) 202111519103.5

(51) Int. Cl. G06T 19/20

(52) U.S. Cl. CPC G06T 19/20; G06T 2219/2024; G06T 2210/16; G10L 15/22

(57) ABSTRACT

A method of generating a virtual character, an electronic device, and a storage medium. A specific implementation solution includes: determining, in response to a first speech command for adjusting an initial virtual character, a target adjustment object corresponding to the first speech command; determining a plurality of character materials related to the target adjustment object; determining a target character material from the plurality of character materials in response to a second speech command for determining the target character material; and adjusting the initial virtual character by using the target character material, so as to generate a target virtual character.

This application claims priority of Chinese Patent Application No. 202111519103.5, filed on Dec. 13, 2021, which is hereby incorporated in its entirety by reference.

### TECHNICAL FIELD

The present disclosure relates to a field of an artificial intelligence technology, in particular to computer vision, speech interaction, virtual/augmented reality and other technologies, and specifically to a method of generating a virtual character, an electronic device, a storage medium, and a program product.

### BACKGROUND

With a rapid development of Internet, 3D (3-Dimensional), Augmented Reality, Virtual Reality and Meta universe technologies, virtual characters are more and more widely used in games, virtual social interactions, interactive marketing, and so on.

### SUMMARY

The present disclosure provides a method of generating a virtual character, an electronic device, a storage medium, and a program product.

According to an aspect of the present disclosure, a method of generating a virtual character is provided, including: determining, in response to a first speech command for adjusting an initial virtual character, a target adjustment object corresponding to the first speech command; determining a plurality of character materials related to the target adjustment object; determining a target character material from the plurality of character materials in response to a second speech command for determining the target character material; and adjusting the initial virtual character by using the target character material, so as to generate a target virtual character.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method described above.

According to another aspect of the present disclosure, a non-transitory computer-readable storage medium having computer instructions therein is provided, and the computer instructions are configured to cause a computer to implement the method described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 schematically shows an exemplary system architecture to which a method and an apparatus of generating a virtual character may be applied according to embodiments of the present disclosure;

FIG. 2 schematically shows a flowchart of a method of generating a virtual character according to embodiments of the present disclosure;

FIG. 3 schematically shows a schematic diagram of a display interface displaying an initial virtual character according to embodiments of the present disclosure;

FIG. 4 schematically shows a schematic diagram of a display interface displaying an initial virtual character according to other embodiments of the present disclosure;

FIG. 5 schematically shows a flowchart of a method of generating a virtual character according to other embodiments of the present disclosure;

FIG. 6 schematically shows a block diagram of an apparatus of generating a virtual character according to embodiments of the present disclosure; and

FIG. 7 schematically shows a block diagram of an electronic device suitable for implementing a method of generating a virtual character according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following descriptions.

The present disclosure provides a method and an apparatus of generating a virtual character, an electronic device, a storage medium, and a program product.

According to embodiments of the present disclosure, a method of generating a virtual character is provided, which may include: determining, in response to a first speech command for adjusting an initial virtual character, a target adjustment object corresponding to the first speech command; determining a plurality of character materials related to the target adjustment object; determining a target character material from the plurality of character materials in response to a second speech command for determining the target character material; and adjusting the initial virtual character by using the target character material, so as to generate a target virtual character

In the technical solution of the present disclosure, an acquisition, a storage, a use, a processing, a transmission, a provision and a disclosure of user personal information involved comply with provisions of relevant laws and regulations, and do not violate public order and good custom.

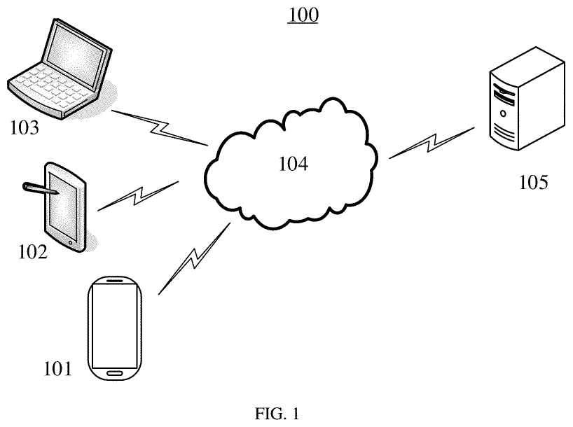

FIG. 1 schematically shows an exemplary system architecture to which a method and an apparatus of generating a virtual character may be applied according to embodiments of the present disclosure.

It should be noted that FIG. 1 is merely an example of a system architecture to which embodiments of the present disclosure may be applied to help those skilled in the art understand the technical content of the present disclosure, but it does not mean that embodiments of the present disclosure may not be applied to other devices, systems, environments or scenarios. For example, in other embodiments, an exemplary system architecture to which a method and an apparatus of generating a virtual character may be applied may include a terminal device, but the terminal device may implement the method and the apparatus of generating the virtual character provided in embodiments of the present disclosure without interacting with a server.

As shown in FIG. 1, a system architecture 100 according to such embodiments may include terminal devices 101, 102 and 103, a network 104, and a server 105. The network 104 is used as a medium for providing a communication link between the terminal devices 101, 102, 103 and the server 105. The network 104 may include various connection types, such as wired and/or wireless communication links, and the like.

The terminal devices 101, 102 and 103 may be used by a user to interact with the server 105 through the network 104, so as to send or receive messages, etc. The terminal devices 101, 102 and 103 may be installed with various communication client applications, such as knowledge reading applications, web browser applications, search applications, instant messaging tools, mailbox clients and/or social platform software, etc. (for example only).

The terminal devices 101, 102 and 103 may be various electronic devices having display screens and supporting web browsing, including but not limited to smartphones, tablet computers, laptop computers, desktop computers, and so on.

The server 105 may be a server that provides various services, such as a background management server (for example only) that provides a support for a content browsed by the user using the terminal devices 101, 102 and 103. The background management server may analyze and process a received user request and other data, and feed back a processing result (for example, a webpage, information or character material acquired or generated according to the user request) to the terminal devices.

It should be noted that the method of generating the virtual character provided by embodiments of the present disclosure may generally be performed by the terminal device 101, 102 or 103. Accordingly, the apparatus of generating the virtual character provided by embodiments of the present disclosure may be generally provided in the terminal device 101, 102 or 103.

Alternatively, the method of generating the virtual character provided by embodiments of the present disclosure may generally be performed by the server 105.

Accordingly, the apparatus of generating the virtual character provided by embodiments of the present disclosure may also be provided in the server 105. The method of generating the virtual character provided by embodiments of the present disclosure may also be performed by a server or server cluster different from the server 105 and capable of communicating with the terminal devices 101, 102, 103 and/or the server 105. Accordingly, the apparatus of generating the virtual character provided by embodiments of the present disclosure may also be provided in a server or server cluster different from the server 105 and capable of communicating with the terminal devices 101, 102, 103 and/or the server 105.

It should be understood that a number of terminal devices, network and server in FIG. 1 are merely schematic. According to the implementation needs, any number of terminal devices, networks and servers may be provided.

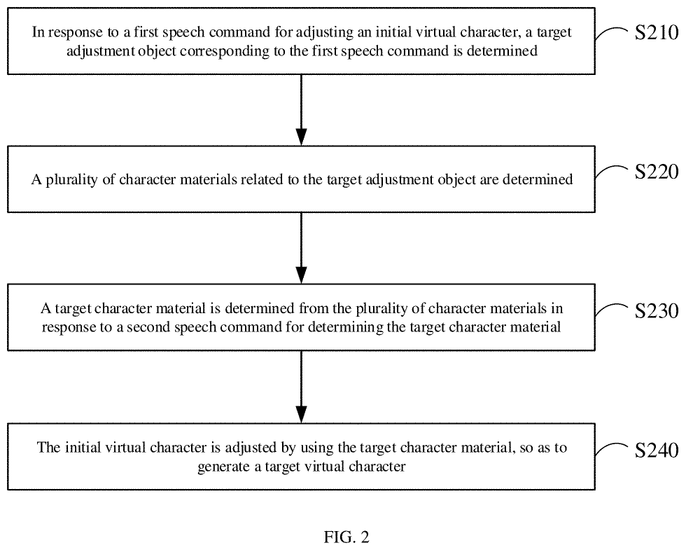

FIG. 2 schematically shows a flowchart of a method of generating a virtual character according to embodiments of the present disclosure.

As shown in FIG. 2, the method includes operation S210 to operation S240.

In operation S210, in response to a first speech command for adjusting an initial virtual character, a target adjustment object corresponding to the first speech command is determined.

In operation S220, a plurality of character materials related to the target adjustment object are determined.

In operation S230, a target character material is determined from the plurality of character materials in response to a second speech command for determining the target character material.

In operation S240, the initial virtual character is adjusted by using the target character material, so as to generate a target virtual character.

According to embodiments of the present disclosure, the virtual character may refer to a synthesized character. In terms of a structure of the virtual character, the virtual character may be a character from a three-dimensional model or a character from a plane image. In terms of a type of the virtual character, the virtual character may be a virtual character formed by simulating a human character, a virtual character formed by simulating an animal character, or a virtual character formed based on a character in a cartoon or comic.

According to embodiments of the present disclosure, the initial virtual character may refer to an initialized template virtual character, or may refer to a character obtained by a user by editing the template virtual character. As long as the virtual character has not been confirmed by the user, it may be defined as the initial virtual character.

According to embodiments of the present disclosure, the first speech command may refer to a command for adjusting the initial virtual character, such as “please update the mouth”, “please provide a material about the mouth”, or other speeches with semantics of adjusting or calling a character material. Embodiments of the present disclosure do not limit a wording of the first speech command, as long as an intention to call a character material or adjust an initial virtual character may be recognized by a semantic recognition technology.

According to embodiments of the present disclosure, a semantic recognition processing may be performed on the first speech command to determine a target adjustment object corresponding to the first speech command. However, it is also possible that a speech command sent by a user does not involve a content of a relevant object. In this case, it is possible to send a speech inquiry such as “which part to be adjusted?” to the user by using a speech interaction function. A speech command for indicating the target adjustment object output by the user after hearing the speech inquiry may be used as the first speech command.

According to embodiments of the present disclosure, the plurality of character materials related to the target adjustment object may be acquired from a character material database. The character material related to the target adjustment object is not limited to a plurality of character materials, and may also be one character material, which may be determined according to a number of character materials pre-stored in the character material database. However, the more character materials are provided, the more for users to choose, which is more conducive to improving a user experience.

According to embodiments of the present disclosure, the plurality of character materials determined to be related to the target adjustment object may be displayed on a predetermined display interface in a form of a list, either in a sequential manner or in a rolling manner. A display manner is not limited, as long as it may display to the user so that the user may determine the target character material from the plurality of character materials.

According to embodiments of the present disclosure, an operation of determining the target character material may be performed in response to the second speech command for determining the target character material. The second speech command may refer to a command for determining the target character material, such as “please select a material with a tag 022”, “please select a girl makeup with a tag ‘gentle”’, or other speeches with semantics of the target character material. Embodiments of the present disclosure do not limit the wording of the second speech command, as long as the intention to determine the target character material may be recognized by the semantic recognition technology.

According to embodiments of the present disclosure, the initial virtual character may be adjusted by using the target character material, so as to generate a target virtual character. For example, it is possible to update the initial virtual character using the target character material, so as to generate the target virtual character, and it is also possible to add the target character material to the initial virtual character to generate the target virtual character, as long as the initial virtual character is adjusted using the target character material to obtain a target virtual character satisfactory to the user.

According to the method of generating the virtual character provided by embodiments of the present disclosure, a character material related to the target adjustment object may be called using a speech interaction function, a target character material may be determined from a plurality of character materials, and the target character material may be combined with the initial virtual character to generate a target virtual character, so that a satisfactory target virtual character may be generated in an efficient and simple manner. Then, in a vehicle-mounted screen scenario, a meta universe scenario or other scenarios in which the user is inconvenient to operate with hands, it is possible to effectively control to generate a personalized target virtual character.

According to embodiments of the present disclosure, before operation S210 is performed, the following operations may be performed to generate the initial virtual character.

For example, a generation speech command for generating an initial virtual character may be received, a semantic information of the generation speech command may be determined; and an initial virtual character matched with the semantic information may be determined.

According to embodiments of the present disclosure, the initial virtual character may be described by the user using a natural language, for example, a generation speech command. The generation speech command input by the user may be recognized using a speech recognition model, and a speech may be converted into a text. For example, a generation speech command “I want a gentle girl character” may be sent from the user. The generation speech command may be converted into a text corresponding to the generation speech command by using a speech recognition model. Subsequently, the text may be analyzed and processed to extract a semantic information such as a key information in the generation speech command, so as to obtain a keyword used to describe the initial virtual character. The keyword may be, for example, “gentle”, “girl”, or the like. According to the keyword extracted by a semantic analysis, a model resource such as “face shape”, “facial features”, “hairstyle” or “clothing” that meets the description may be matched from a model resource library.

According to embodiments of the present disclosure, the model resource such as the facial feature, the hairstyle or the clothing in the model resource library may be understood as a character material about the facial feature, a character material about the hairstyle or a character material about the clothing in the character material database, but it is not limited to this. The model resources in the model resource library may be completely different from the character materials in the character material database, so as to avoid a case that the plurality of character materials displayed to the user in response to the first speech command of the user include the model resource for generating the initial virtual character, which may occupy a display region for displaying the plurality of character materials.

According to the method of generating the virtual character provided by embodiments of the present disclosure, the initial virtual character may be automatically generated by using the generation speech command of the user, so as to avoid a problem that the user needs to spend a lot of time and energy on a selection of each part when a large number of parts such as the facial feature, the hairstyle or the clothing are provided to construct the initial virtual character.

According to the method of generating the virtual character provided by embodiments of the present disclosure, it is possible to reduce a professional 3D modeling knowledge and reduce manpower and financial costs, so that multi-style and multi-personality virtual characters such as virtual digital humans may be created by non-professional users.

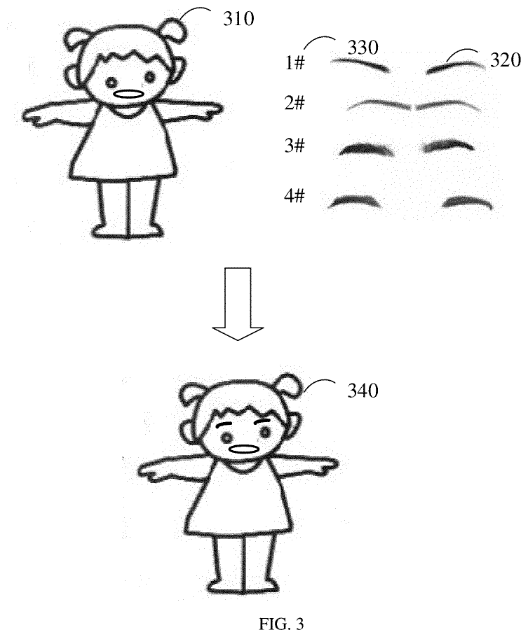

FIG. 3 schematically shows a schematic diagram of a display interface for displaying an initial virtual character according to embodiments of the present disclosure.

As shown in FIG. 3, an initial virtual character 310 may be a character of a virtual digital human. The initial virtual character may be a virtual human character for which a character appearance such as the hairstyle, the facial feature, the clothing and so on have been constructed.

The initial virtual character may be a virtual character generated by using a virtual character template, but it is not limited thereto. The initial virtual character may also be a virtual character generated by an adjustment by the user on a basis of the virtual character template. The initial virtual character may be a virtual character that has not met a user standard. In this case, a virtual character of other styles and personalities may be described to a terminal device such as a computer, a vehicle-mounted screen or the like by the user using a natural language, just like a daily conversation. For example, a first speech command may be sent to express an intention to adjust the initial virtual character. The target adjustment object in the first speech command may be the facial feature, the hairstyle, the clothing, and so on. A plurality of character materials related to the target adjustment object may be determined according to the target adjustment object in the first speech command, and the plurality of character materials may be of one type, such as character materials related to the facial feature, more specifically, character materials 320 related to eyebrows. However, the present is not limited to this, and the plurality of character materials may also be of multiple types, such as materials related to the clothing and materials related to the hairstyle.

As shown in FIG. 3, the determined plurality of character materials may be displayed in a character material display region of a display interface, for example, all may be displayed in a tiled manner. An image of each character material may be marked with a character material identification tag 330, so that when a second speech command for determining the target character material is sent from the user, the target character material may be indicated clearly by using the character material identification label, and the terminal device may semantically recognize the target character material from the second speech command conveniently, thereby improving a speech interaction ability between the user and the terminal device.

As shown in FIG. 3, in a case that the target character material is determined by the user, an initial virtual character 310 may be adjusted using the target character material, so as to generate a target virtual character 340.

In a case of a large number of character materials, the character materials may be displayed in a scrolling manner due to a limited region for displaying the character materials, so that all materials may be completely browsed by the user without a manual operation; and with the speech interaction function, it is only required to send, for example, the first speech command and the second speech command to trigger a request, so that the virtual character may be generated more intelligently and conveniently.

According to embodiments of the present disclosure, operation S240 of adjusting the initial virtual character by using the target character material so as to generate a target virtual character may include the following operations.

For example, an initial virtual sub-character of the initial virtual character may be determined according to the target adjustment object. The initial virtual sub-character may be updated using the target character material, so as to generate the target virtual character.

According to embodiments of the present disclosure, the target adjustment object may refer to a part to be adjusted of the initial virtual character. For example, hair may be used as the target adjustment object, or a mouth may be used as the adjustment object. The initial virtual sub-character may be a resource model or a character material corresponding to the target adjustment object. In a case of determining the initial virtual sub-character according to the target adjustment object, the initial virtual sub-character may be quickly updated by using the target character material to obtain the target virtual character.

According to embodiments of the present disclosure, updating the initial virtual sub-character using the target character material may be understood as replacing the initial virtual sub-character with the target character material. For example, if the target adjustment object is eyes, eyes of the initial virtual sub-character such as eyes with double eyelids may be replaced with the target character material specified by the user, such as eyes with single eyelids, so as to generate a target virtual character having eyes with single eyelids. However, the present disclosure is not limited to this. Updating the initial virtual sub-character using the target character material may also refer to adding the target character material to the initial virtual character. For example, if the target adjustment object is a hair ornament, and no hair ornament is involved in the initial virtual character, then it is determined that the initial virtual sub-character is none. In a case of determining that the initial virtual sub-character is none, the target character material may be added to the initial virtual character to generate the target virtual character.

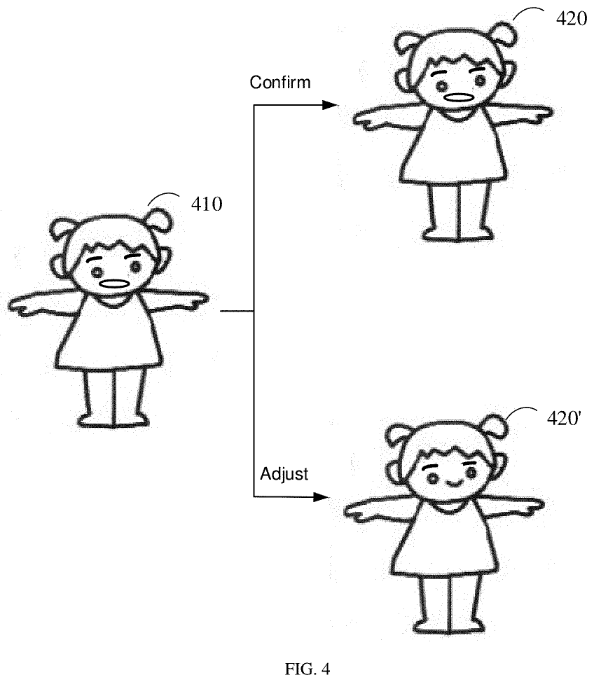

FIG. 4 schematically shows a schematic diagram of a display interface for displaying an initial virtual character according to embodiments of the present disclosure.

As shown in FIG. 4, when the initial virtual sub-character is updated by using the target character material, a virtual sub-character to be confirmed 410 may be generated. In this case, a query information, such as a query speech information, may be output to the user, or a query text information may be displayed on the display interface and may be combined with the query speech information. The inquiry information may be an information containing semantics of whether to confirm the virtual sub-character 410 to be confirmed, for example, “are you satisfied with this image?” In response to a reply speech information indicating a satisfaction from the user, the virtual sub-character to be confirmed may be determined as a target virtual character 420.

In response to a third speech command for adjusting the virtual sub-character to be confirmed 410 sent by the user, a bone node in the virtual sub-character to be confirmed 410 may be adjusted to generate a target virtual character 420′.

According to embodiments of the present disclosure, the third speech command may refer to a command for adjusting the virtual sub-character to be confirmed, such as “please change to a smaller face” or “please make the mouth smaller” and other speeches with semantics for adjustment. Embodiments of the present disclosure do not limit the wording of the third speech command, as long as an intention to adjust the virtual sub-character to be confirmed may be recognized by a semantic recognition technology.

According to embodiments of the present disclosure, the bone node may refer to each bone node in a bone tree in a three-dimensional model. The three-dimensional model may refer to a three-dimensional model of a face. The bone tree may be designed according to a geometric structure of the face, and a weight influence relationship may be established between each skin mesh node of a bone skin and each bone node in the bone tree. Then, a deformation of each bone node may be transmitted to each skin mesh node of the bone skin through a rotation, a translation, a scaling and so on of the bone node in the bone tree, so as to achieve a deformation of each skin mesh node.

According to embodiments of the present disclosure, a keyword related to adjusting the virtual character to be confirmed in the third speech command, such as “mouth”, “smaller” or the like, may be extracted through a semantic recognition technology. Then, adjustment data for the bone node corresponding to the semantic information may be determined, and the bone node of the virtual character to be confirmed may be adjusted using the adjustment data, so as to obtain the target virtual character.

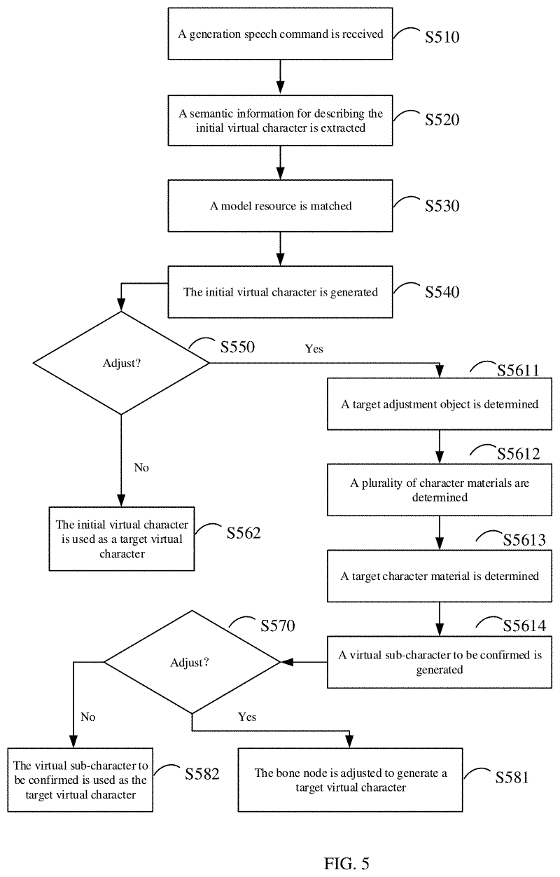

FIG. 5 schematically shows a flowchart of a method of generating a virtual character according to other embodiments of the present disclosure.

As shown in FIG. 5, the method may include operations S510 to S550, S5611 to S5614, S562, S570, and S581 to S582.

In operation S510, a generation speech command for generating an initial virtual character input by a user speech is received.

In operation S520, a semantic information for describing the initial virtual character is extracted from the generation speech command.

In operation S530, a model resource in a model resource library is matched.

In operation S540, the initial virtual character is generated.

In operation S550, it is determined whether to adjust the initial virtual character.

In operation S5611, a target adjustment object is determined according to a first speech command if it is determined that an adjustment is required.

In operation S5612, a plurality of character materials related to the target adjustment object are determined.

In operation S5613, a target character material is determined from the plurality of character materials according to a second speech command.

In operation S5614, the initial virtual character is adjusted using the target character material, so as to generate a virtual sub-character to be confirmed.

In operation S562, the initial virtual character is used as a target virtual character if it is determined that no modification is required.

In operation S570, it is determined whether to adjust a bone node in a virtual sub-character to be confirmed.

In operation S581, the bone node is adjusted according to a third speech command if it is determined that a modification is required, so as to generate a target virtual character.

In operation S582, the virtual sub-character to be confirmed is used as the target virtual character if no modification is required.

According to the method of generating the virtual character provided by embodiments of the present disclosure, the target virtual character may be generated through a plurality of rounds of editing of the initial virtual character, so that a satisfaction of the target virtual character may be improved, and the generation method may be more flexible and intelligent. In addition, different methods such as the adjustment of bone node or the update of character material may be used in the plurality of rounds of editing, which may make up for defects that the number of character materials is limited or the character materials are predetermined and may not be adjusted.

According to embodiments of the present disclosure, after operation S240 of adjusting the initial virtual character by using the target character material to generate the target virtual character is performed, the following operation of displaying the target virtual character may be further performed.

For example, an action information for feedback may be determined in response to the target virtual character being generated. A speech information for feedback may be determined. The target virtual character, the action information and the speech information may be merged to generate a target video.

According to embodiments of the present disclosure, when the target virtual character is generated, the target virtual character with an action information, an expression information and a speech information may be displayed with an animation effect.

For example, for a target virtual character having a gender of “male”, a target video may be generated with a gesture of “greeting”, an action of turning a circle, and a speech of “Hello, I am your exclusive virtual character!”

According to embodiments of the present disclosure, an action information for inquiry may be determined in response to the virtual sub-character to be confirmed being generated. A speech inquiry information may be determined. The virtual sub-character to be confirmed, the action information for inquiry and the speech inquiry information may be merged to generate an inquiry video for confirming the virtual sub-character to be confirmed.

According to embodiments of the present disclosure, when adjusting the bone node in the virtual sub-character to be confirmed in response to the third speech command for adjusting the virtual sub-character to be confirmed sent from the user, the adjustment may fail. When it is determined that the adjustment fails, the virtual sub-character to be confirmed, an action information for feeding back the virtual sub-character to be confirmed, and a speech information for feeding back the virtual sub-character to be confirmed may be merged to generate a feedback video for indicating a failure of the adjustment.

For example, if the bone node in the virtual sub-character to be confirmed is adjusted and the adjustment fails, the virtual sub-character to be confirmed may be used as a final virtual character. For example, “It's a pity that the modification failed” may be used as the speech information for feeding back the virtual sub-character to be confirmed. A gesture action of “spreading hands” may be used as the action information for feeding back the virtual sub-character to be confirmed. These three may be merged to obtain a feedback video for indicating the failure of the adjustment.

According to embodiments of the present disclosure, a method of generating the action information for feedback, a method of generating the speech information for feedback, and a method of integrating the target virtual character, the action information and the speech information are not limited, and any generation method or merging method known in the art may be used.

According to embodiments of the present disclosure, determining the speech information for feedback may include the following operations.

For example, a character attribute feature information of the target virtual character is determined; a sound attribute feature information matched with the character attribute feature information of the target virtual character is determined; and the speech information for feedback is determined according to the sound attribute feature information.

According to embodiments of the present disclosure, the character attribute feature information may include at least one selected from, for example, a gender, an age, an occupation, a personality, a height, an appearance, or the like. The sound attribute feature information may include at least one selected from, for example, a volume feature information, a voiceprint feature information, a timbre feature information, a tone feature information, an emotion feature information, a speech content, or the like.

According to embodiments of the present disclosure, determining the action information for feedback may include the following operations.

For example, a character attribute feature information of the target virtual character is determined; an action attribute feature information matched with the character attribute feature information of the target virtual character is determined; and the action information for feedback is determined according to the action attribute feature information.

According to embodiments of the present disclosure, the character attribute feature information may include at least one selected from, for example, a gender, an age, an occupation, a personality, a height, an appearance, or the like. The action attribute feature information may include at least one selected from, for example, an action range feature information, an action part feature information, an action type feature information, an emotion feature information, or the like.

According to embodiments of the present disclosure, the sound attribute feature information matched with the character attribute feature information of the target virtual character may be determined according to a semantic similarity. For example, the semantic similarity between the character attribute feature information and the sound attribute feature information is greater than or equal to a predetermined similarity threshold. However, the present disclosure is not limited to this. It may also be possible to recognize, according to a predetermined matching mapping table, a sound attribute feature information matched with the character attribute feature information from the predetermined matching mapping table according to the character attribute feature information.

According to embodiments of the present disclosure, the action attribute feature information matched with the character attribute feature information of the target virtual character may be determined according to a semantic similarity. For example, the semantic similarity between the character attribute feature information and the action attribute feature information is greater than or equal to a predetermined similarity threshold. However, the present disclosure is not limited to this. It may also be possible to recognize, according to a predetermined matching mapping table, an action attribute feature information matched with the character attribute feature information from the predetermined matching mapping table according to the character attribute feature information.

For example: when generating a boy character, a target video may be generated with actions such as “elegant salute”, “greet”, “smile” and a speech feedback such as “Hello, I am your exclusive virtual character”. When generating a girl character, a target video may be generated with animations such as “princess salute”, “smile”, “blink” and a speech feedback such as “Hi, I am the virtual character generated for you”.

According to the method of generating the virtual character provided by embodiments of the present disclosure, an interest and a user experience may be improved, and a personalized need of the user may be met.

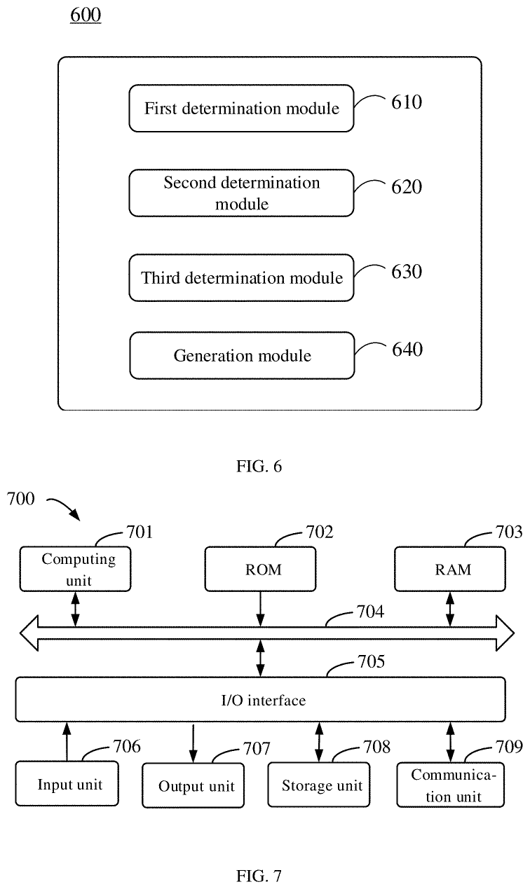

FIG. 6 schematically shows a block diagram of an apparatus of generating a virtual character according to embodiments of the present disclosure.

As shown in FIG. 6, an apparatus 600 of generating a virtual character may include a first determination module 610, a second determination module 620, a third determination module 630, and a generation module 640.

The first determination module 610 may be used to determine, in response to a first speech command for adjusting an initial virtual character, a target adjustment object corresponding to the first speech command.

The second determination module 620 may be used to determine a plurality of character materials related to the target adjustment object.

The third determination module 630 may be used to determine a target character material from the plurality of character materials in response to a second speech command for determining the target character material.

The generation module 640 may be used to adjust the initial virtual character by using the target character material, so as to generate a target virtual character.

According to embodiments of the present disclosure, the generation module may include a first determination sub-module and a generation sub-module.

The first determination sub-module may be used to determine an initial virtual sub-character of the initial virtual character based on the target adjustment object.

The generation sub-module may be used to update the initial virtual sub-character by using the target character material, so as to generate the target virtual character.

According to embodiments of the present disclosure, the generation sub-module may include an update unit and an adjustment unit.

The update unit may be used to update the initial virtual sub-character by using the target character material, so as to generate a virtual sub-character to be confirmed.

The adjustment unit may be used to adjust, in response to a third speech command for adjusting the virtual sub-character to be confirmed, a bone node in the virtual sub-character to be confirmed, so as to generate the target virtual character.

According to embodiments of the present disclosure, subsequent to the generation module, the apparatus of generating the virtual character may further include a fourth determination module, a fifth determination module, and a merging module.

The fourth determination module may be used to determine an action information for feedback, in response to the target virtual character being generated.

The fifth determination module may be used to determine a speech information for feedback.

The merging module may be used to merge the target virtual character, the action information and the speech information, so as to generate a target video.

According to embodiments of the present disclosure, the fifth determination module may include a first determination unit, a second determination unit, and a third determination unit.

The first determination unit may be used to determine a character attribute feature information of the target virtual character.

The second determination unit may be used to determine a sound attribute feature information matched with the character attribute feature information of the target virtual character.

The third determination unit may be used to determine the speech information for feedback according to the sound attribute feature information.

According to embodiments of the present disclosure, the apparatus of generating the virtual character may further include a receiving module and an initial character determination module.

The receiving module may be used to receive a generation speech command for generating the initial virtual character, and determine a semantic information of the generation speech command.

The initial character determination module may be used to determine the initial virtual character matched with the semantic information.

According to embodiments of the present disclosure, at least one character material in the plurality of character materials includes at least one selected from: a character material related to clothing, a character material related to a facial feature, or a character material related to a hairstyle.

According to embodiments of the present disclosure, the present disclosure further provides an electronic device, a readable storage medium, and a computer program product.

According to embodiments of the present disclosure, the present disclosure further provides an electronic device, including: at least one processor; and a memory communicatively connected to the at least one processor, the memory stores instructions executable by the at least one processor, and the instructions, when executed by the at least one processor, cause the at least one processor to implement the method described above.

According to embodiments of the present disclosure, the present disclosure further provides a non-transitory computer-readable storage medium having computer instructions therein, and the computer instructions are used to cause a computer to implement the method described above.

According to embodiments of the present disclosure, the present disclosure further provides a computer program product containing a computer program, and the computer program, when executed by a processor, causes the processor to implement the method described above.

FIG. 7 shows a schematic block diagram of an example electronic device 700 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 7, an electronic device 700 includes a computing unit 701 which may perform various appropriate actions and processes according to a computer program stored in a read only memory (ROM) 702 or a computer program loaded from a storage unit 708 into a random access memory (RAM) 703. In the RAM 703, various programs and data necessary for an operation of the electronic device 700 may also be stored. The computing unit 701, the ROM 702 and the RAM 703 are connected to each other through a bus 704. An input/output (I/O) interface 705 is also connected to the bus 704.

A plurality of components in the electronic device 700 are connected to the I/O interface 705, including: an input unit 706, such as a keyboard, or a mouse; an output unit 707, such as displays or speakers of various types; a storage unit 708, such as a disk, or an optical disc; and a communication unit 709, such as a network card, a modem, or a wireless communication transceiver. The communication unit 709 allows the electronic device 700 to exchange information/data with other devices through a computer network such as Internet and/or various telecommunication networks.

The computing unit 701 may be various general-purpose and/or dedicated processing assemblies having processing and computing capabilities. Some examples of the computing units 701 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 701 executes various methods and steps described above, such as the method of generating the virtual character. For example, in some embodiments, the method of generating the virtual character may be implemented as a computer software program which is tangibly embodied in a machine-readable medium, such as the storage unit 708. In some embodiments, the computer program may be partially or entirely loaded and/or installed in the electronic device 700 via the ROM 702 and/or the communication unit 709. The computer program, when loaded in the RAM 703 and executed by the computing unit 701, may execute one or more steps in the method of generating the virtual character described above. Alternatively, in other embodiments, the computing unit 701 may be used to perform the method of generating the virtual character by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, speech input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

A computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of generating a virtual character, the method comprising:
determining, in response to a first speech command for adjusting an initial virtual character, a target adjustment object corresponding to the first speech command;
determining a plurality of character materials related to the target adjustment object;
determining a target character material from the plurality of character materials in response to a second speech command for determining the target character material; and
adjusting the initial virtual character by using the target character material, so as to generate a target virtual character.

2. The method according to claim 1, wherein the adjusting the initial virtual character by using the target character material, so as to generate a target virtual character comprises:
determining an initial virtual sub-character of the initial virtual character based on the target adjustment object; and
updating the initial virtual sub-character by using the target character material, so as to generate the target virtual character.

3. The method according to claim 2, wherein the updating the initial virtual sub-character by using the target character material, so as to generate the target virtual character comprises:
updating the initial virtual sub-character by using the target character material, so as to generate a virtual sub-character to be confirmed; and
adjusting, in response to a third speech command for adjusting the virtual sub-character to be confirmed, a bone node in the virtual sub-character to be confirmed, so as to generate the target virtual character.

4. The method according to claim 1, further comprising: subsequent to adjusting the initial virtual character by using the target character material, so as to generate a target virtual character,
determining an action information for feedback, in response to the target virtual character being generated;
determining a speech information for feedback; and
merging the target virtual character, the action information and the speech information, so as to generate a target video.

5. The method according to claim 4, wherein the determining a speech information for feedback comprises:
determining a character attribute feature information of the target virtual character;
determining a sound attribute feature information matched with the character attribute feature information of the target virtual character; and
determining the speech information for feedback according to the sound attribute feature information.

6. The method according to claim 1, further comprising:
receiving a generation speech command for generating the initial virtual character, and determining a semantic information of the generation speech command; and
determining the initial virtual character matched with the semantic information.

7. The method according to claim 1, wherein at least one character material in the plurality of character materials comprises at least one selected from: a character material related to clothing, a character material related to a facial feature, or a character material related to a hairstyle.

8. An electronic device, comprising:
at least one processor; and
a memory communicatively connected to the at least one processor, wherein the memory stores instructions executable by the at least one processor, the instructions, when executed by the at least one processor, configured to cause the at least one processor to:
determine, in response to a first speech command for adjusting an initial virtual character, a target adjustment object corresponding to the first speech command;
determine a plurality of character materials related to the target adjustment object;
determine a target character material from the plurality of character materials in response to a second speech command for determining the target character material; and
adjust the initial virtual character by using the target character material, so as to generate a target virtual character.

9. The electronic device according to claim 8, wherein the instructions, when executed by the at least one processor, are further configured to cause the processor to:
determine an initial virtual sub-character of the initial virtual character based on the target adjustment object; and
update the initial virtual sub-character by using the target character material, so as to generate the target virtual character.

10. The electronic device according to claim 9, wherein the instructions, when executed by the at least one processor, are further configured to cause the processor to:
update the initial virtual sub-character by using the target character material, so as to generate a virtual sub-character to be confirmed; and
adjust, in response to a third speech command for adjusting the virtual sub-character to be confirmed, a bone node in the virtual sub-character to be confirmed, so as to generate the target virtual character.

11. The electronic device according to claim 8, wherein the instructions, when executed by the at least one processor, are further configured to cause the processor to:
determine an action information for feedback, in response to the target virtual character being generated;
determine a speech information for feedback; and
merge the target virtual character, the action information and the speech information, so as to generate a target video.

12. The electronic device according to claim 11, wherein the instructions, when executed by the at least one processor, are further configured to cause the processor to:
determine a character attribute feature information of the target virtual character;
determine a sound attribute feature information matched with the character attribute feature information of the target virtual character; and
determine the speech information for feedback according to the sound attribute feature information.

13. The electronic device according to claim 8, wherein the instructions, when executed by the at least one processor, are further configured to cause the processor to:
receive a generation speech command for generating the initial virtual character, and determining a semantic information of the generation speech command; and
determine the initial virtual character matched with the semantic information.

14. The electronic device according to claim 8, wherein at least one character material in the plurality of character materials comprises at least one selected from: a character material related to clothing, a character material related to a facial feature, or a character material related to a hairstyle.

15. A non-transitory computer-readable storage medium having computer instructions therein, the computer instructions configured to cause a computer system to at least:
determine, in response to a first speech command for adjusting an initial virtual character, a target adjustment object corresponding to the first speech command;
determine a plurality of character materials related to the target adjustment object;
determine a target character material from the plurality of character materials in response to a second speech command for determining the target character material; and
adjust the initial virtual character by using the target character material, so as to generate a target virtual character.

16. The storage medium according to claim 15, wherein the computer instructions are further configured to cause the computer system to:
determine an initial virtual sub-character of the initial virtual character based on the target adjustment object; and
update the initial virtual sub-character by using the target character material, so as to generate the target virtual character.

17. The storage medium according to claim 16, wherein the computer instructions are further configured to cause the computer system to:
update the initial virtual sub-character by using the target character material, so as to generate a virtual sub-character to be confirmed; and
adjust, in response to a third speech command for adjusting the virtual sub-character to be confirmed, a bone node in the virtual sub-character to be confirmed, so as to generate the target virtual character.

18. The storage medium according to claim 15, wherein the computer instructions are further configured to cause the computer system to:
determine an action information for feedback, in response to the target virtual character being generated;
determine a speech information for feedback; and
merge the target virtual character, the action information and the speech information, so as to generate a target video.

19. The storage medium according to claim 18, wherein the computer instructions are further configured to cause the computer system to:
determine a character attribute feature information of the target virtual character;
determine a sound attribute feature information matched with the character attribute feature information of the target virtual character; and
determine the speech information for feedback according to the sound attribute feature information.

20. The storage medium according to claim 15, wherein the computer instructions are further configured to cause the computer system to:
receive a generation speech command for generating the initial virtual character, and determining a semantic information of the generation speech command; and
determine the initial virtual character matched with the semantic information.
